(19) United States
(12) Patent Application Publication
(10) Pub. No.: US 2009/0249063 A1
(43) Pub. Date: Oct. 1, 2009

(54) ENCRYPTION DATA MANAGEMENT SYSTEM AND ENCRYPTION DATA MANAGEMENT METHOD

(75) Inventors: Hideki SAKURAI, Kawasaki (JP); Yasuo NOGUCHI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/414,580

(22) Filed: Mar. 30, 2009

(30) Foreign Application Priority Data
Mar. 31, 2008 (JP) 2008-092699

(51) Int. Cl. H04L 29/06

(52) U.S. Cl. 713/159; 713/155

(57) ABSTRACT

A system includes an agent-side apparatus and an owner-side apparatus. The agent-side apparatus includes a transmission unit for responding to operation inputs from an agent, and a transfer unit for transferring a data processing request to the owner-side apparatus, and transferring a processing result to a management object apparatus. The owner-side apparatus includes a commission condition storage unit in which a commission condition of the agent; an agent authentication unit for authenticating authentication information; a performing unit for performing data processing associated with decryption of an encryption data, when the agent authentication unit normally performs the authentication, and when the data processing request falls within a range of the agent commission condition, upon receiving the data processing request from the agent-side apparatus; and a result transmission unit for transmitting the processing result of the performing unit to the agent-side apparatus.

### CROSS-REFERENCE TO RELATED APPLICATIONS

This application is related to and claims priority to Japanese patent application No. 2008-92699 filed on Mar. 31, 2008 in the Japan Patent Office, and incorporated by reference herein.

### FIELD

The present invention relates to an encryption data management system and an encryption data management method for managing encryption data, particularly to an encryption data management system and an encryption data management method capable of decrypting the encryption data by connecting a device in which a secret key is stored.

### BACKGROUND

Generally, in user authentication with a computer system, verification is performed between authentication information on each user stored in a server and authentication information fed from the user. Examples of the authentication system include a system in which the authentication is performed by an agent located in a site different from the server and a system in which the authentication information on an agent is previously registered in the computer system of an operating object and an access to secret information is permitted to the corresponding agent.

In a system in which higher security is required, sometimes a mechanism in which important information is protected by encrypting data using a public key is applied in addition to the user authentication. The encrypted data can be decrypted using a secret key possessed only by an owner of the data. In operation of the public key cryptosystem, the secret key is incorporated in a tamper-resistant device. The tamper-resistant device has a structure in which the secret key cannot be taken out, and the tamper-resistant device has a function of encrypting/decrypting the data using the secret key. For example, in decrypting the encryption data encrypted with the public key, it is necessary that, using the secret key, the device decrypt the encryption data fed into the device. An IC card can be cited as an example of the tamper-resistant device.

When the secret information is protected by the secret key, in principle an owner of the secret key carries the IC card to go to the site where the secret key is required.

In the case where the computer system is operated in a firm or the like, sometimes maintenance and management of the computer system are commissioned to another firm. Sometimes an access to the secret information is required in the maintenance and management work of the computer system. Work efficiency is lowered when the owner of the computer system brings the IC card to the work site every time the access to the secret information is required. Therefore, the owner commissions, to an agent, the authority of the maintenance and management work in which the secret information is utilized.

However, from the viewpoint of security, it is not desireable that the owner commissions the whole authority to the agent. That is, it is necessary that the IC card in which the secret key is incorporated be lent to the agent when the owner commissions the work in which the secret information is utilized to the agent. When the owner lends the IC card to the agent, the agent has the same authority as the owner, and a large risk is generated for the owner. Sometimes the site where the management object system is installed is located far away from the owner. When the owner lends the IC card to the agent who goes to the remote site, the owner seldom monitors the agent which further increases the risk.

### SUMMARY

According to an aspect of this invention, an encryption data management system includes an agent-side apparatus and an owner-side apparatus to manage encryption data stored in encryption data storage unit of a management object apparatus. The agent-side apparatus includes a transmission unit for responding to operation inputs from an agent to transmit authentication information indicating proxy of the agent to the owner-side apparatus; and a transfer unit for transferring a data processing request including the encryption data to the owner-side apparatus when the management object apparatus supplies the data processing request, and then transferring processing result to the management object apparatus, the processing result corresponding to the data processing request sent back from the owner-side apparatus. The owner-side apparatus includes a commission condition storage unit in which a commission condition of the agent who uses the agent-side apparatus is previously stored; an agent authentication unit for authenticating authentication information when the authentication information of the agent is received from the agent-side apparatus; a performing unit for performing data processing associated with decryption of the encryption data included in the permitted data processing request using a previously registered key, when the agent authentication unit normally performs the authentication, and when the data processing request falls within a range of the agent commission condition indicated by the commission condition storage unit, upon receiving the data processing request from the agent-side apparatus; and a result transmission unit for transmitting the processing result of the performing unit to the agent-side apparatus.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an outline of an embodiment;

FIG. 2 illustrates an example of a system configuration of the embodiment;

FIG. 3 illustrates an example of a hardware configuration of an agent device used in the embodiment;

FIG. 4 is a block diagram illustrating an encryption data management function;

FIG. 5 illustrates an example of a data structure of a commission condition storage unit;

FIG. 6 is a sequence diagram illustrating a processing procedure when data processing is normally performed;

FIG. 7 is a sequence diagram illustrating a processing procedure when the data processing results in an authentication error;

FIG. 8 is a sequence diagram illustrating a processing procedure when an owner IC card is removed;

FIG. 9 is a flowchart illustrating a procedure of processing request permission determination processing;

FIG. 10 illustrates an example of connection in which a USB interface is used;

FIG. 11 illustrates an example in which an agent IC card function is incorporated in a device main body;

FIG. 12 illustrates an example of an owner device in which a plurality of owner IC cards can be used;

FIG. 13 illustrates an example in which plural owner IC card functions are incorporated in a device main body;

FIG. 14 is a functional block diagram illustrating a system in which agent authentication is performed by a public key system;

FIG. 15 illustrates an example of a data structure of a commission condition storage unit; and

FIG. 16 is a sequence diagram illustrating an authentication procedure in which a public key is used.

### DESCRIPTION OF EMBODIMENTS

An embodiment of the invention will be described below with reference to the accompanying drawings.

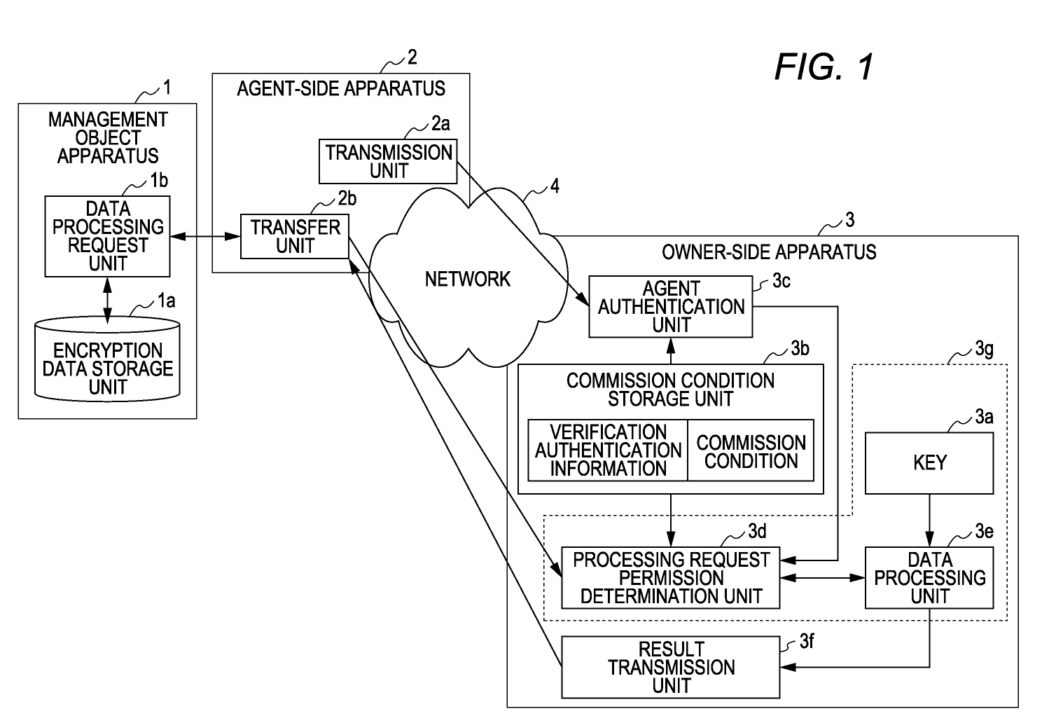

FIG. 1 illustrates an outline of an embodiment of the invention. Referring to FIG. 1, an encryption data management system includes a management object apparatus 1, an agent-side apparatus 2, and an owner-side apparatus 3 which is connected to the agent-side apparatus 2 through a network.

The management object apparatus 1 includes an encryption data storage unit 1a and a data processing request unit 1b. The encryption data storage unit 1a can be decrypted only with a key 3a possessed by the owner-side apparatus 3. For example, in the case of the public key system, the key 3a is the secret key, and the encryption data encrypted with the public key corresponding to the secret key is stored in the encryption data storage unit 1a. When detecting an access to the encryption data in the encryption data storage unit 1a, the data processing request unit 1b transmits a data processing request including the access object encryption data to the agent-side apparatus 2.

The agent-side apparatus 2 includes a transmission unit 2a and a transfer unit 2b. The transmission unit 2a transmits authentication information indicating that an agent has proxy to the owner-side apparatus 3 in response to operation input from the agent. The transfer unit 2b transfers a data processing request to the owner-side apparatus 3 when the management object apparatus 1 supplies the data processing request including the encryption data. The owner-side apparatus 3 sends back a processing result in response to the data processing request, and the transfer unit 2b transfers the processing result to the management object apparatus 1.

The owner-side apparatus 3 includes the key 3a, a commission condition storage unit 3b, an agent authentication unit 3c, a processing request permission determination unit 3d, a data processing unit 3e, and a result transmission unit 3f. A performing unit 3g for performing processing includes the key 3a, the processing request permission determination unit 3d, and the data processing unit 3e.

The key 3a is data which is used to decrypt the encryption data stored in the management object apparatus 1. Verification authentication information for authenticating the agent and a commission condition of the agent who uses the agent-side apparatus 2 are previously stored in the commission condition storage unit 3b. When receiving the authentication information from the agent-side apparatus 2, the agent authentication unit 3c authenticates the agent who operates the agent-side apparatus 2 based on the authentication information. The processing request permission determination unit 3d receives the data processing request from the agent-side apparatus 2 to permit processing corresponding to the data processing request, when the agent who operates the agent-side apparatus 2 is correctly authenticated, and when the processing falls within a range of the agent commission condition indicated by the commission condition storage unit 3b. When the processing corresponding to the data processing request is permitted, the data processing unit 3e performs the data processing associated with the decryption of the encryption data included in the permitted data processing request using the key 3a. The result transmission unit 3f transmits the processing result to the agent-side apparatus 2.

In the encryption data management system, the agent-side apparatus 2 transmits the authentication information indicating that the agent has the proxy to the owner-side apparatus 3 in response to the input operation from the agent. Then the owner-side apparatus 3 authenticates the agent who operates the agent-side apparatus 2 based on the authentication information. When the management object apparatus 1 supplies the data processing request including the encryption data, the agent-side apparatus 2 transfers the data processing request to the owner-side apparatus 3. The processing request permission determination unit 3d of the owner-side apparatus 3 permits the processing corresponding to the data processing request, when the agent who operates the agent-side apparatus 2 is correctly authenticated, and when the commission condition of the agent who operates the agent-side apparatus 2 falls within the range of the agent commission condition indicated by the commission condition storage unit 3b. When the processing is permitted, the data processing unit 3e performs the data processing associated with the decryption of the encryption data included in the permitted data processing request. The result transmission unit 3f transmits the processing result to the agent-side apparatus 2. The agent-side apparatus 2 transfers the processing result to the management object apparatus 1.

Thus, the owner-side apparatus performs the processing associated with the decryption of the encryption data within the range of the commission condition imparted to the agent, in the case of the data processing request made through the agent-side apparatus 2 used by the authenticated agent. That is, the owner can commission the maintenance and management of the management object apparatus 1, associated with the data processing in which the encryption data is used, to the agent while the key 3a is left in the owner-side apparatus 3. As a result, it is unnecessary for the owner to impart the authority to completely freely process the encryption data stored in the management object apparatus 1 to the agent, thereby reducing the risk of the information security.

The technique is particularly useful in the case where the management object apparatus 1 is remotely installed. This is because the management object apparatus 1 is cannot be monitored by the owner when the agent goes to the remote management object apparatus 1 to perform the maintenance and management.

From the viewpoint of security, preferably the key 3a of the owner-side apparatus 3 is stored in the IC card rather than being always stored in the owner-side apparatus 3, and the IC card is inserted into the owner-side apparatus 3 only when needed. The embodiment will be described below by taking the case in which the key is managed in the IC card as an example.

### First Embodiment

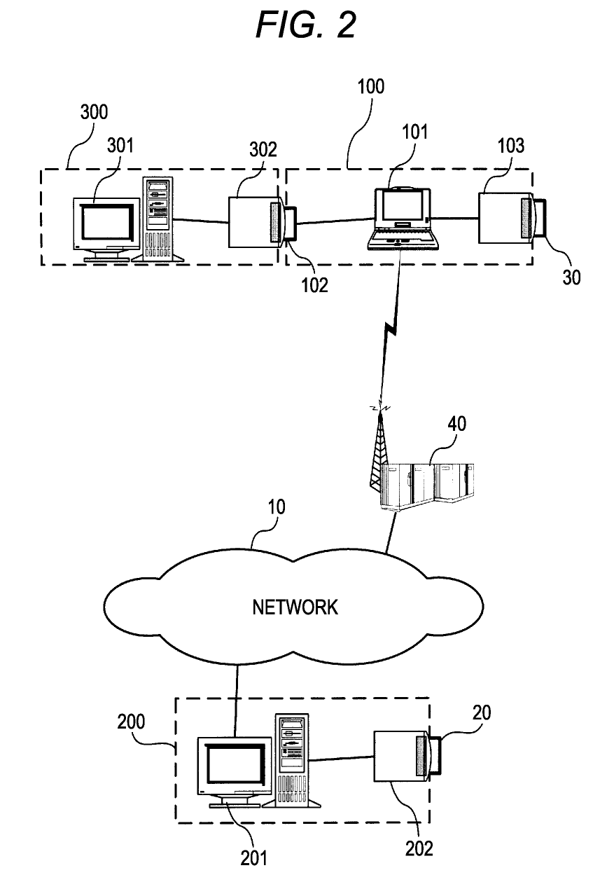

FIG. 2 illustrates an example of a system configuration of the embodiment. The encryption data management system of the embodiment includes an agent device 100, an owner device 200, and a management object system 300. The agent device 100 is a device possessed by an operator (agent) who performs the maintenance and management of the management object system 300 on behalf of the owner. The owner device 200 is a device which is installed at a location of the owner of information stored in the management object system 300. The management object system 300 is a computer system which retains the information on the owner, and manages part of the information while the part of the information is encrypted with the public key.

The agent device 100 includes a device main body 101, a card-type probe 102, and an IC card reader/writer 103. For example, the device main body 101 may be a notebook computer. The device main body 101 is connected to a network 10 through a radio base station 40 by a wireless communication function. The agent-side apparatus is formed by adding an agent IC card 30 to the agent device 100.

The card-type probe 102 and the IC card reader/writer 103 are connected to the device main body 101 by a communication method such as USB (Universal Serial Bus). The card-type probe 102 can be inserted in an IC card reader/writer 302 included in the management object system 300, and the IC card reader/writer 302 can recognize the card-type probe 102 as a usual IC card. The IC card reader/writer 103 reads data in the inserted agent IC card 30.

The owner device 200 includes a device main body 201 and an IC card reader/writer 202. For example, the device main body 201 may be a computer used by the owner. The device main body 201 is connected to the network 10. The IC card reader/writer 202 performs data exchange with the inserted owner IC card 20. The owner-side apparatus is formed by adding the owner IC card 20 to the owner device 200.

The management object system 300 includes a device main body 301 in which the encryption data is stored and an IC card reader/writer 302. For example, the device main body 301 may be a computer which performs security management in a large-scale database system. The IC card reader/writer 302 performs the data exchange through the card-type probe 102.

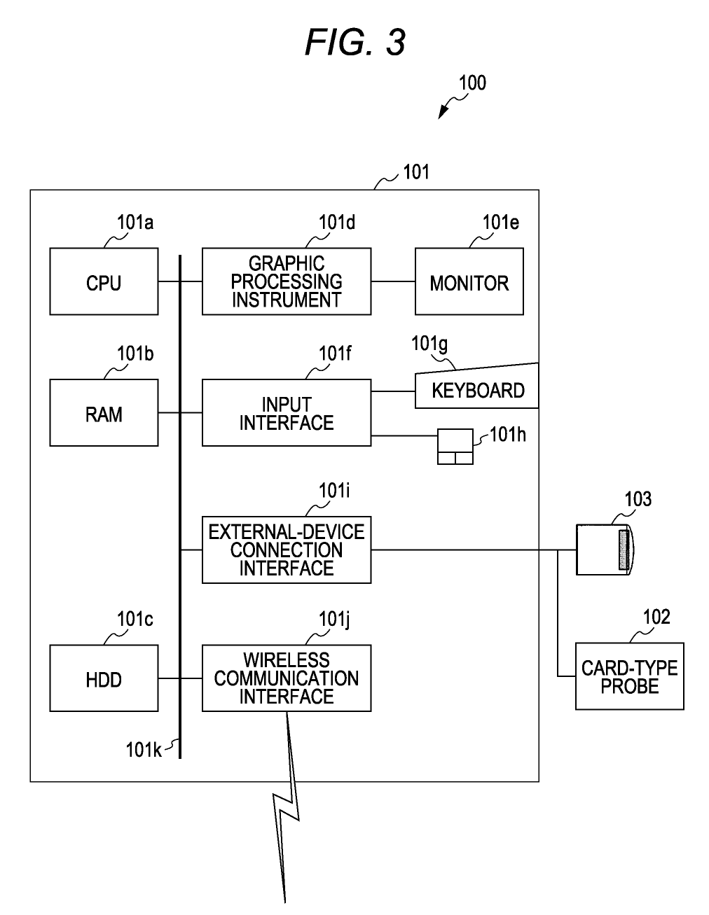

FIG. 3 illustrates an example of a hardware configuration of the agent device used in the embodiment. A CPU (Central Processing Unit) 101a controls the device main body 101 of the agent device 100. A RAM (Random Access Memory) 101b, a Hard Disk Drive (HDD) 101c, a graphic processing instrument 101d, an input interface 101f, an external-device connection interface 101i, and a wireless communication interface 101j are connected to the CPU 101a though a bus 101k.

The RAM 101b is used as a main storage device of the device main body 101. At least a part of an OS (Operating System) program and an application program, which the CPU 101a is caused to execute, is tentatively stored in the RAM 101b. Various pieces of data necessary for the processing performed by the CPU 101a are stored in the RAM 101b. The HDD 101c is used as a secondary storage device of the device main body 101. The OS program, the application program, and various pieces of data are stored in the HDD 101c. A semiconductor storage device such as a flash memory can also be used as the secondary storage device.

A monitor 101e is connected to the graphic processing instrument 101d. The graphic processing instrument 101d causes the monitor 101e to display an image on a screen according to a command from the CPU 101a. A liquid crystal display device may be cited as an example of the monitor 101e.

A keyboard 101g and a pointing device 101h are connected to the input interface 101f. The input interface 101f transmits a signal sent from the keyboard 101g and pointing device 101h to the CPU 101a through a bus 101k. Examples of the pointing device 101h include a mouse, a touch panel, a tablet, a touch pad, and a track ball.

The external-device connection interface 101i is a communication interface which conducts communication with an external device. A USB interface may be cited as an example of the external-device connection interface 101i. The card-type probe 102 and the IC card reader/writer 103 are connected to the external-device connection interface 101i.

The wireless communication interface 101j is a communication interface which can wirelessly conduct data communication. The wireless communication interface 101j conducts wireless communication with a radio base station 40.

The processing function of the embodiment can be realized by the above-described hardware configuration. Although FIG. 3 illustrates the hardware configuration of the agent device 100, the owner device 200 and the management object system 300 can also be realized by the similar hardware configuration. However, a network interface which can directly be connected to the network 10 may be provided for the owner device 200 instead of the wireless communication interface.

An encryption data management function will be described below.

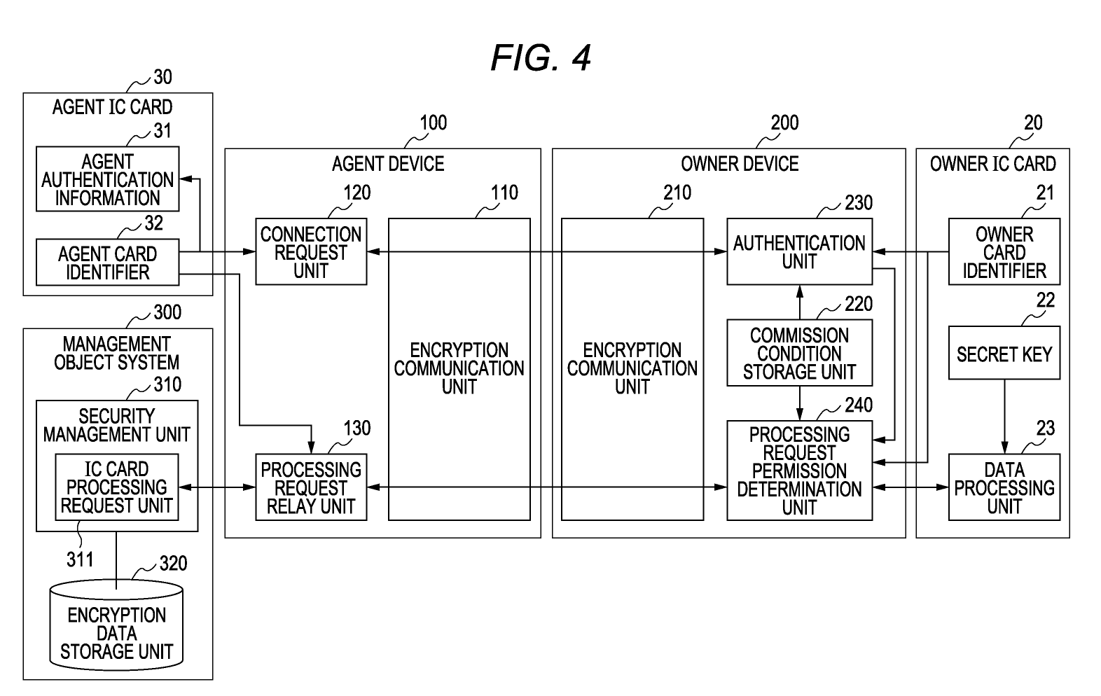

FIG. 4 is a block diagram illustrating the encryption data management function. The owner IC card 20 includes an owner card identifier 21, a secret key 22, and a data processing unit 23. The owner card identifier 21 is identification information which is used to uniquely identify the owner IC card 20. The owner card identifier 21 is stored in a ROM (Read Only Memory) of the owner IC card 20. The secret key 22 is key data which is used to decrypt the encryption data stored in an encryption data storage unit 320 of a management object system 300. The secret key 22 is stored in a highly tamper-resistant memory of the owner IC card 20.

The data processing unit 23 encrypts and decrypts the data using the secret key 22. For example, an encryption/decryption circuit provided in the owner IC card 20 may act as the data processing unit 23.

The agent IC card 30 has a memory, and agent authentication information 31 and an agent card identifier 32 are stored in the memory. The agent authentication information 31 is authentication information which is used to authenticate the agent. In the embodiment, a set of a user name and a password of the agent is used as the authentication information. The owner having the owner IC card 20 sets the agent authentication information 31 in the agent IC card 30. The agent card identifier 32 is identification information which is used to uniquely identify the agent IC card 30.

The agent device 100 includes an encryption communication unit 110, a connection request unit 120, and a processing request relay unit 130. The encryption communication unit 110 conducts the data communication with the owner device 200 in an encryption manner.

The connection request unit 120 makes a connection request to the owner device 200 in response to the operation input from the agent. When accepting the operation input for instructing the connection, the connection request unit 120 reads the agent authentication information 31 and the agent card identifier 32 from the agent IC card 30. Then the connection request unit 120 transmits the connection request including the agent authentication information 31 and the agent card identifier 32 to the owner device 200 through the encryption communication unit 110.

Alternatively, the connection request unit 120 does not read the agent authentication information 31 from the agent IC card 30, but obtains the agent authentication information 31 from the operation input performed by the agent.

The processing request relay unit 130 transfers the encryption data processing request made by the management object system 300 to the owner device 200. The processing request relay unit 130 obtains the agent card identifier 32 from the agent IC card 30 when receiving the processing request including the encryption data stored in the encryption data storage unit 320 from the management object system 300. The processing request relay unit 130 transmits the processing request, to which the agent card identifier 32 is imparted, to the owner device 200 through the encryption communication unit 110.

The owner device 200 includes an encryption communication unit 210, a commission condition storage unit 220, an authentication unit 230, and a processing request permission determination unit 240. The encryption communication unit 210 conducts the data communication with the agent device 100 in an encryption manner.

The commission condition storage unit 220 is a storage function of storing authentication information on an agent having the agent IC card 30 and a commission condition imparted to the agent. For example, a part of an HDD storage area included in the device main body 201 of the owner device 200 is used as the commission condition storage unit 220.

The authentication unit 230 authenticates the agent based on the connection request transmitted from the agent device 100. The authentication unit 230 extracts the agent card identifier 32 and the agent authentication information 31 from the connection request. Then, the authentication unit 230 searches for the authentication information corresponding to a set of the agent card identifier 32 and the owner card identifier 21 of the owner IC card 20 from the commission condition storage unit 220. The authentication unit 230 checks the applicable authentication information with the agent authentication information 31 included in the connection request. When the applicable authentication information matches the agent authentication information 31, the authentication unit 230 determines that the agent is authorized, and notifies the agent device 100 of the authentication result. In the case of the successful authentication, the authentication unit 230 notifies the processing request permission determination unit 240 of the authenticated set of the agent card identifier 32 and the owner card identifier 21.

The processing request permission determination unit 240 determines whether or not the processing request is permitted based on the processing request transmitted from the agent device 100. When receiving the processing request from the agent device 100, the processing request permission determination unit 240 determines whether or not the processing request is transmitted from the successfully authenticated agent based on the agent card identifier 32 imparted to the processing request. Then, the processing request permission determination unit 240 obtains the commission condition corresponding to the set of the agent card identifier 32 and the owner card identifier 21 of the owner IC card 20 from the commission condition storage unit 220. The processing request permission determination unit 240 determines whether or not the processing request falls within the range of the commission condition of the agent. When the processing request falls within the range of the commission condition of the successfully authenticated agent, the processing request permission determination unit 240 transmits the processing request to the owner IC card 20. Upon receiving the processing result from the owner IC card 20, the processing request permission determination unit 240 transmits the processing result to the agent device 100 through the encryption communication unit 210.

The management object system 300 includes a security management unit 310 and the encryption data storage unit 320. The security management unit 310 manages security of the data in the management object system 300. Only the access to the encryption data through the security management unit 310 is permitted when the process of executing various programs in the management object system 300 accesses the encryption data. That is, when the agent requires the decryption of the encryption data in the system maintenance and management work, the security management unit 310 performs the processing corresponding to a decryption request in which the encryption data is specified.

The security management unit 310 includes an IC card processing request unit 311 which is one of the security management functions. The IC card processing request unit 311 makes a request to perform the encryption data processing to the owner IC card 20 when the access to the encryption data is obtained. When receiving the request to decrypt the encryption data, the IC card processing request unit 311 obtains the encryption data specified by the encryption data storage unit 320. The IC card processing request unit 311 transmits the processing request indicating the processing for decrypting the obtained encryption data to the agent device 100. The management object system 300 and the agent device 100 are connected to the IC card reader/writer 302 of the management object system 300 by the card-type probe 102 of the agent device 100, which is inserted in the IC card reader/writer 302. Accordingly, the IC card processing request unit 311 recognizes that the agent IC card 30 is inserted in the IC card reader/writer 302.

The encryption data is stored in the encryption data storage unit 320. The encryption data is encrypted by the public key which is simultaneously produced along with the secret key 22 of the owner IC card 20. The encryption data which is encrypted by the public key can be decrypted only by the secret key 22.

Contents of the commission condition storage unit 220 will be described below.

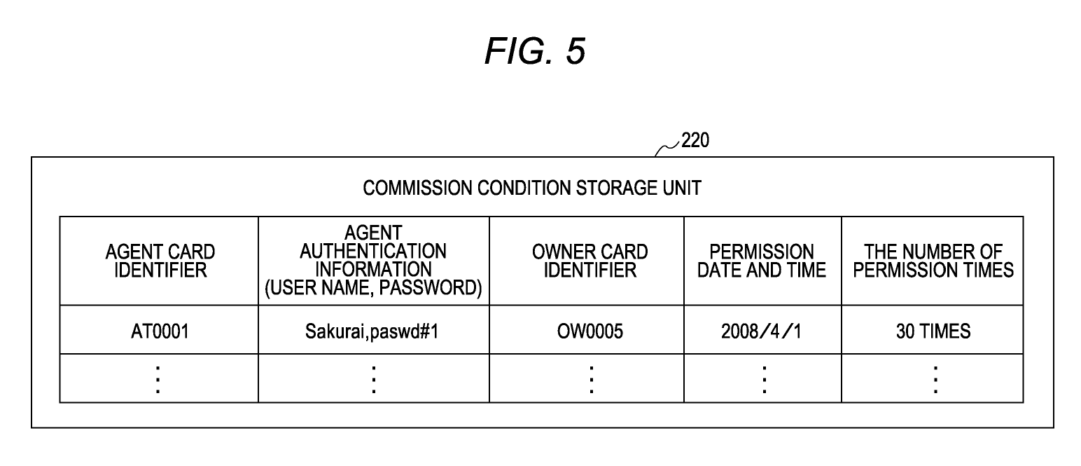

FIG. 5 illustrates an example of a data structure of the commission condition storage unit 220. Fields such as an agent card identifier, agent authentication information, an owner card identifier, a permission date and time, and the number of permission times are provided in the commission condition storage unit 220.

The identification information (agent card identifier) on the agent IC card 30 delivered to the agent is set in the agent card identifier field. The agent authentication information is set in the agent authentication information field. Referring to FIG. 5, a user name and a password of the owner are set as the authentication information. The identification information of the owner IC card 20 (owner card identifier) possessed by the owner is set in the owner card identifier field. The date and time in which the proxy is permitted to the agent (permission date and time) are set in the permission date and time field. A period can also be set in the permission date and time filed by using a starting date and time and an ending date and time. The number of times the data processing is permitted with the owner IC card 20 (number of permission times) is set in the field of the number of permission times.

Thus, in the commission condition storage unit 220, the authentication information and the commission conditions (permission date and time and the number of permission times) of the agent are set in correlation to the settings of the owner IC card 20 and the agent IC card. Accordingly, the agent authentication and the determination of whether or not the processing request from the agent is permitted can be made by referring to the commission condition storage unit 220.

In the system having the above-described configuration, the owner can perform the data processing including the decryption of the encryption data in the remote management object system 300 while keeping the owner IC card 20 at hand. The data processing including the decryption of the encryption data will be described below.

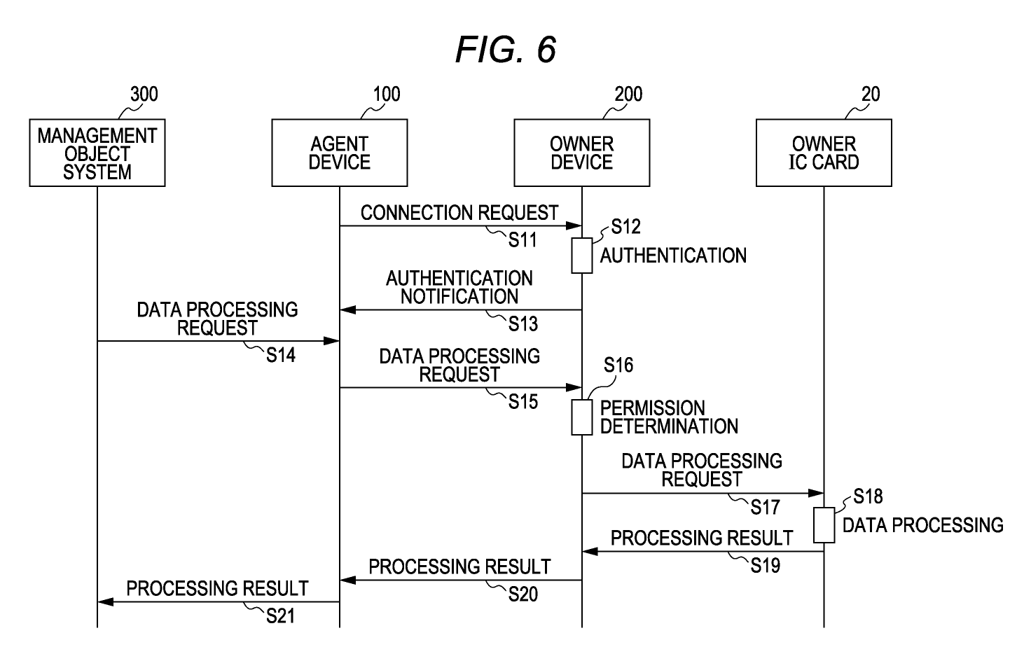

FIG. 6 is a sequence diagram illustrating a processing procedure when data processing is normally performed. FIG. 6 illustrates processing performed by the management object system 300, agent device 100, owner device 200, and owner IC card 20. The processing shown in FIG. 6 will be described.

(Step S11) The agent device 100 transmits the connection request to the owner device 200 in response to the operation input from the agent. The connection request unit 120 of the agent device 100 accepts the operation input for instructing the connection with the owner device 200. Then the connection request unit 120 obtains the agent authentication information 31 and the agent card identifier 32 from the agent IC card 30. The connection request unit 120 produces the connection request including the agent authentication information 31 and the agent card identifier 32. The produced connection request is encrypted by the encryption communication unit 110 and transmitted to the owner device 200 by the wireless communication.

(Step S12) The owner device 200 performs the user authentication of the agent in response to the connection request. The encryption communication unit 210 of the owner device 200 receives the connection request transmitted from the agent device 100. The encryption communication unit 210 decrypts the received connection request to deliver the connection request to the authentication unit 230. The authentication unit 230 obtains the owner card identifier 21 from the owner IC card 20. Then, the authentication unit 230 retrieves for the authentication information corresponding to the set of the obtained owner card identifier 21 and the agent card identifier 32 included in the connection request from the commission condition storage unit 220. The authentication unit 230 checks the retrieved authentication information with the agent authentication information 31 included in the connection request. When the user name and the password match each other, the authentication unit 230 determines that the agent is authorized.

(Step S13) When the authentication is successful, the authentication unit 230 transmits authentication notification indicating that the agent is correctly authenticated to the agent device 100. The authentication unit 230 delivers the authentication notification to the encryption communication unit 210. The encryption communication unit 210 encrypts the authentication notification and transmits the authentication notification to the agent device 100. In the agent device 100, the encryption communication unit 110 receives the encrypted authentication notification. The encryption communication unit 110 decrypts the authentication notification and delivers the authentication notification to the connection request unit 120. When receiving the authentication notification, the connection request unit 120 displays the successful authentication on the monitor 101e of the agent device 100.

The authentication unit 230 of the owner device 200 delivers the correctly-authenticated set of the agent card identifier 32 and the owner card identifier 21 to the processing request permission determination unit 240.

(Step S14) The agent performs the operation input to the management object system 300 to perform the maintenance and management work. The security management unit 310 of the management object system 300 obtains the access object encryption data from the encryption data storage unit 320 when detecting the access to the encryption data 320 during the maintenance and management work. The IC card processing request unit 311 of the security management unit 310 transmits the data processing request including the encryption data to the agent device 100.

(Step S15) The agent device 100 transfers the data processing request to the owner device 200. The processing request relay unit 130 of the agent device 100 receives the data processing request transmitted from the management object system 300. When receiving the data processing request including the encryption data from the management object system 300, the processing request relay unit 130 obtains the agent card identifier 32 from the agent IC card 30 and imparts the agent card identifier 32 to the data processing request. The processing request relay unit 130 delivers the data processing request to the encryption communication unit 110. The encryption communication unit 110 encrypts the data processing request and transmits the data processing request to the owner device 200.

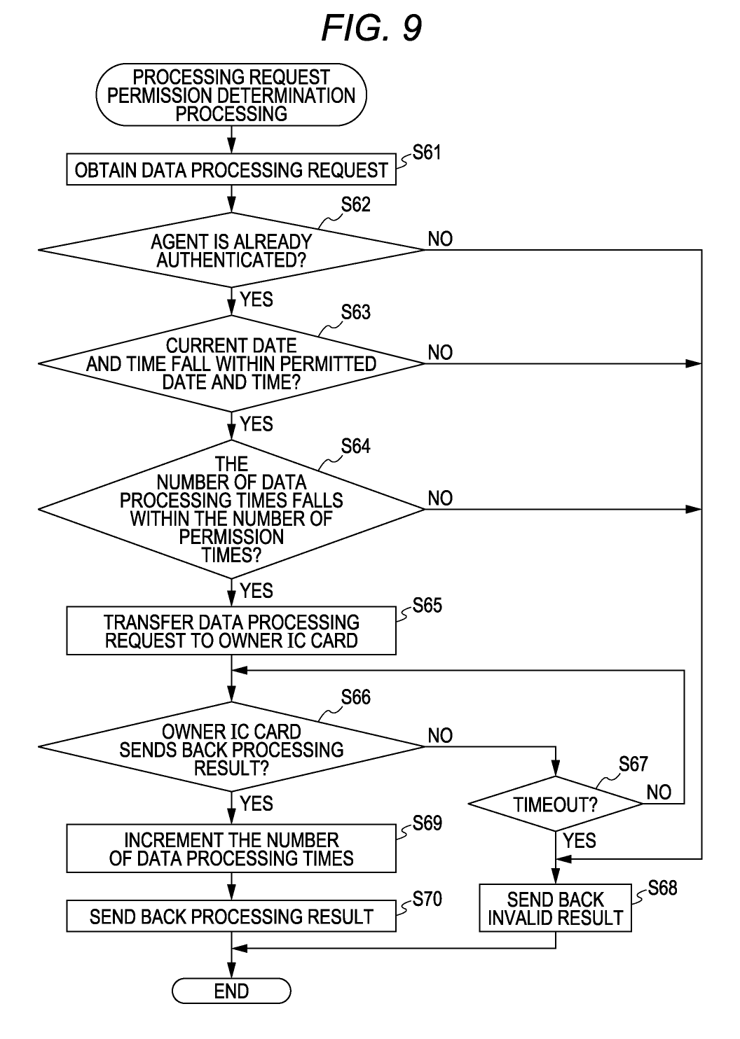

(Step S16) The owner device 200 makes the permission determination. The encryption communication unit 210 of the owner device 200 receives the data processing request transmitted from the agent device 100. The encryption communication unit 210 decrypts the encrypted data processing request and delivers the data processing request to the processing request permission determination unit 240. The processing request permission determination unit 240 refers to the commission condition storage unit 220 to determine whether or not the data processing request is permitted. The processing for determining whether or not the data processing request is permitted will be described in detail later (see FIG. 9). In the example of FIG. 6, it is assumed that the data processing request is permitted.

(Step S17) The agent device 100 transmits the data processing request to the owner IC card 20. When the data processing request is permitted, the processing request permission determination unit 240 of the owner device 200 deletes the agent card identifier 32 from the data processing request. The processing request permission determination unit 240 transmits the data processing request, from which the agent card identifier 32 is removed, to the owner IC card 20.

(Step S18) The owner IC card 20 performs the data processing in response to the data processing request. In the owner IC card 20, the data processing unit 23 receives the data processing request. The data processing unit 23 decrypts the encryption data included in the data processing request using the secret key 22.

(Step S19) The data processing unit 23 transmits the decrypted plaintext data which is the processing result to the owner device 200.

(Step S20) The owner device 200 transmits the processing result received from the owner IC card 20 to the agent device 100. The processing request permission determination unit 240 of the owner device 200 delivers the processing result received from the owner IC card 20 to the encryption communication unit 210. The encryption communication unit 210 encrypts the processing result received from the processing request permission determination unit 240 and transmits the processing result to the agent device 100.

(Step S21) When receiving the processing result from the owner device 200, the agent device 100 transfers the processing result to the management object system 300. In the agent device 100, the encryption communication unit 110 receives the processing result. The encryption communication unit 110 decrypts the received processing result and delivers the processing result to the processing request relay unit 130. The processing request relay unit 130 transmits the processing result to the management object system 300 in response to the data processing request made by the management object system 300. In the management object system 300, the data processing associated with the maintenance and management is performed based on the processing result.

Thus, the encryption data is decrypted using the secret key 22 stored in the owner IC card 20.

The processing in the case where the agent authentication results in an error will be described below.

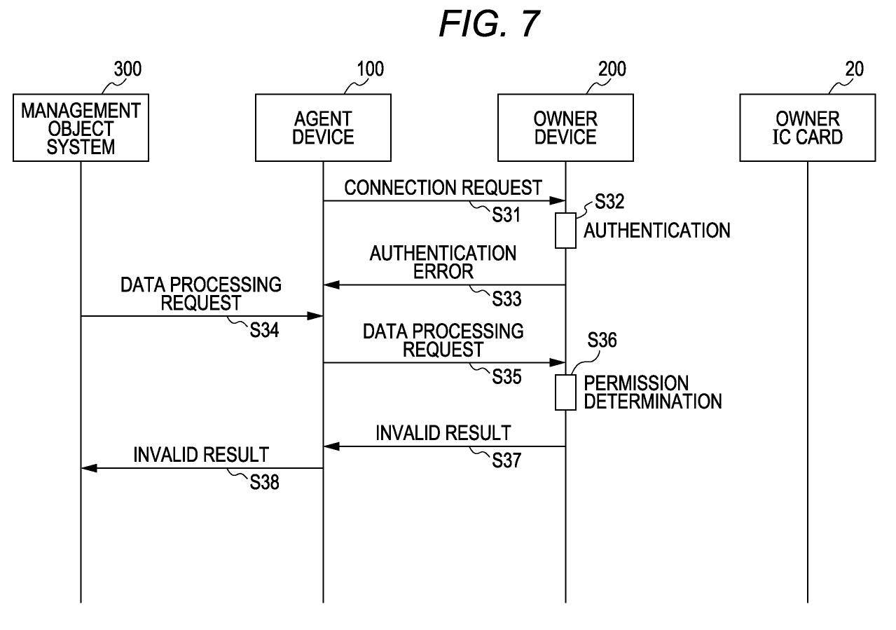

FIG. 7 is a sequence diagram illustrating a processing procedure when the agent authentication results in an error. The processing shown in FIG. 7 will be described with step numbers.

(Step S31) The agent device 100 transmits the connection request to the owner device 200 in response to the operation input from the agent. The detailed processing is similar to that in Step S11 of FIG. 6.

(Step S32) The owner device 200 performs the user authentication in response to the connection request. The detailed processing is similar to that in Step S12 of FIG. 6. In the example of FIG. 7, it is assumed that the authentication information obtained from the commission condition storage unit 220 does not match the agent authentication information 31 included in the connection request.

(Step S33) The authentication unit 230 of the owner device 200 notifies the agent device 100 of an authentication error. The authentication unit 230 delivers a message (authentication error message) indicating the authentication error to the encryption communication unit 210. The encryption communication unit 210 encrypts the authentication error message and transmits the authentication error message to the agent device 100. In the agent device 100, the encryption communication unit 110 receives the authentication error message. The encryption communication unit 110 decrypts the authentication error message and delivers the authentication error message to the connection request unit 120. The connection request unit 120 displays the failed authentication on the monitor 101e.

(Step S34) The agent may perform the work in which the management object system 300 is used in the case of the maintenance and management work not using the encryption data. However, when the agent provides an instruction in which the encryption data is utilized to the management object system 300, the security management unit 310 of the management object system 300 detects the access to the encryption data 320 during the maintenance and management work. The security management unit 310 obtains the access object encryption data from the encryption data storage unit 320. The IC card processing request unit 311 of the security management unit 310 transmits the data processing request including the encryption data to the agent device 100.

(Step S35) The agent device 100 transfers the data processing request to the owner device 200. The detailed processing is similar to that in Step S15 of FIG. 6.

(Step S36) The owner device 200 makes the permission determination. The detailed processing is similar to that in Step S16 of FIG. 6. In the example of FIG. 7, it is assumed that authentication unit 230 fails in the agent authentication. Therefore, the authentication unit 230 does not notify the processing request permission determination unit 240 of the agent card identifier 32 of the agent IC card 30. The processing request permission determination unit 240 recognizes that the unauthorized agent makes the data processing request because the authentication unit 230 does not notify the processing request permission determination unit 240 of the agent card identifier 32 imparted to the data processing request. Accordingly, the processing request permission determination unit 240 makes a determination that the data processing request is rejected.

(Step S37) The owner device 200 transmits the invalid result to the agent device 100. The processing request permission determination unit 240 of the owner device 200 delivers information (invalid information) indicating that the data processing request is invalid to the encryption communication unit 210. The encryption communication unit 210 encrypts the processing result received from the processing request permission determination unit 240 and transmits the processing result to the agent device 100.

(Step S38) When receiving the invalid result from the owner device 200, the agent device 100 transfers the invalid result to the management object system 300. In the agent device 100, the encryption communication unit 110 receives the invalid result. The encryption communication unit 110 decrypts the invalid result and delivers the invalid result to the processing request relay unit 130. The processing request relay unit 130 transmits the invalid result to the management object system 300 in response to the data processing request made by the management object system 300. In the management object system 300, the processing with the encryption data is error-ended due to the response of the invalid result.

Thus, the owner device 200 rejects the data processing request made by the unauthorized agent.

While the agent performs the maintenance and management work of the management object system 300, it is necessary for the owner to insert the owner IC card 20 into the IC card reader/writer 202 of the owner device 200. Even if the owner IC card 20 is inserted in the IC card reader/writer 202 when the agent starts the work, the subsequent processes with the encryption data are not performed when the owner removes the owner IC card 20 from the IC card reader/writer 202. That is, when learning that the agent performs unscheduled work, the owner can remove the owner IC card 20 from the IC card reader/writer 202 to protect the important data.

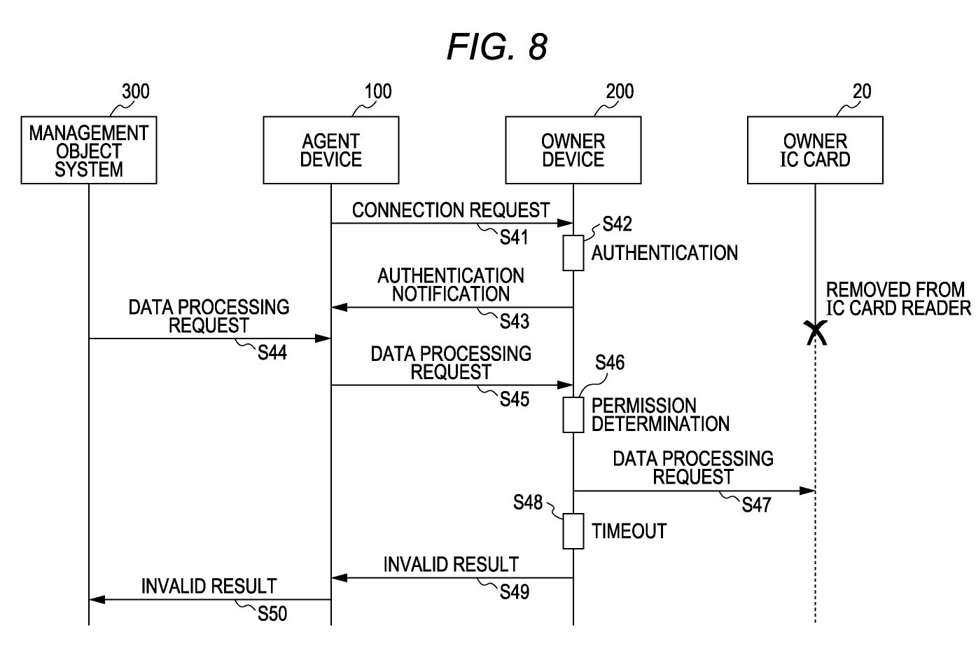

FIG. 8 is a sequence diagram illustrating a processing procedure when the owner IC card is removed. The processes illustrated in FIG. 8 will be described below with numbers.

(Step S41) The agent device 100 transmits the connection request to the owner device 200 in response to the operation input from the agent. The detailed processing is similar to that in Step S11 of FIG. 6.

(Step S42) The owner device 200 performs the user authentication of the agent in response to the connection request. The detailed processing is similar to that in Step S12 of FIG. 6. In the example of FIG. 8, it is assumed that the owner IC card 20 is inserted in the IC card reader/writer 202 and the agent is correctly authenticated at this stage.

(Step S43) In the case of the correct authentication, the authentication unit 230 transmits the authentication notification indicating the correct authentication to the agent device 100. The detailed processing is similar to that in Step S13 of FIG. 6.

(Step S44) The agent performs the operation input to the management object system 300 to perform the maintenance and management work. It is assumed that the owner removes the owner IC card 20 from the IC card reader/writer 202 during the maintenance and management work. Then, when the security management unit 310 of the management object system 300 detects the access to the encryption data 320 during the maintenance and management work, the security management unit 310 obtains the access object encryption data from the encryption data storage unit 320. The IC card processing request unit 311 of the security management unit 310 transmits the data processing request including the encryption data to the agent device 100.

(Step S45) The agent device 100 transfers the data processing request to the owner device 200. The detailed processing is similar to that in Step S15 of FIG. 6.

(Step S46) The owner device 200 makes the permission determination. The detailed processing is similar to that in Step S16 of FIG. 6. In the example of FIG. 8, it is assumed that the data processing request is permitted.

(Step S47) The agent device 100 transmits the data processing request to the owner IC card 20. The detailed processing is similar to that in Step S17 of FIG. 6. In the example of FIG. 8, it is assumed that the data processing request is permitted. At this point, the owner IC card 20 is already removed from the IC card reader/writer 202. Therefore, there is no response of the processing result from the owner IC card 20.

(Step S48) The agent device 100 detects a timeout. The processing request permission determination unit 240 of the agent device 100 starts time measurement since the data processing request is transmitted to the owner IC card 20. A waiting time for a response to the data processing request is previously defined in the processing request permission determination unit 240. When an elapsed time after the data processing request is transmitted exceeds the waiting time, the processing request permission determination unit 240 determines that the timeout is detected.

(Step S49) The processing request permission determination unit 240 transmits the invalid result to the agent device 100. The detailed processing is similar to that in Step S37 of FIG. 7.

(Step S50) When receiving the invalid result from the owner device 200, the agent device 100 transfers the invalid result to the management object system 300. The detailed processing is similar to that in Step S38 of FIG. 7.

Thus, the subsequent pieces of processing with the encryption data are prohibited in the case where the owner removes the owner IC card 20. That is, even if the owner is remotely located from the management object system 300, the owner can instantaneously cancel the proxy when the need for canceling the proxy of the agent arises.

Then the processing performed by the processing request permission determination unit 240 will be described in detail.

FIG. 9 is a flowchart illustrating a procedure of processing request permission determination processing. The processing illustrated in FIG. 9 will be described below.

(Step S61) The processing request permission determination unit 240 obtains the data processing request transmitted from the agent device 100 via the encryption communication unit 210.

(Step S62) The processing request permission determination unit 240 determines whether or not the agent is already authenticated. The processing request permission determination unit 240 retains the set of the agent card identifier and owner card identifier of which the authentication unit 230 notifies the processing request permission determination unit 240 as already-authenticated card information. When receiving the data processing request, the processing request permission determination unit 240 obtains the agent card identifier 32 imparted to the data processing request while obtaining the owner card identifier 21 from the owner IC card 20. The processing request permission determination unit 240 determines whether or not the set of the agent card identifier 32 and the owner card identifier 21 matches one of the pieces of already-authenticated card information previously delivered from the authentication unit 230. When the set of the agent card identifier 32 and the owner card identifier 21 matches one of the pieces of already-authenticated card information, the processing request permission determination unit 240 determines that the agent is already authenticated. When the agent is already authenticated, the flow goes to Step S63. When the agent is not authenticated, the flow goes to Step S68.

(Step S63) The processing request permission determination unit 240 determines whether or not the current date and time fall within the permission date and time. The processing request permission determination unit 240 obtains the owner card identifier 21 from the owner IC card 20. The processing request permission determination unit 240 extracts the commission conditions (the permission date and time and the number of permission times) corresponding to the set of the agent card identifier 32 of the data processing request and the owner card identifier 21 from the commission condition storage unit 220. The processing request permission determination unit 240 determines whether or not the permission date and time of the extracted commission condition includes the current date and time. When the permission date and time includes the current date and time, the flow goes to Step S64. When the permission date and time does not include the current date and time, the flow goes to Step S68.

(Step S64) The processing request permission determination unit 240 determines whether or not the number of data processing times falls within the number of permission times. The processing request permission determination unit 240 stores the number of data processing times while correlating the number of data processing times with the set of the agent card identifier 32 and owner card identifier 21 (already-authenticated card information) received from the authentication unit 230. The number of data processing times is initialized to zero when the already-authenticated card information is delivered from the authentication unit 230. The processing request permission determination unit 240 determines whether or not the number of permission times of the commission condition extracted in Step S63 is larger than the number of data processing times. That is, the processing request permission determination unit 240 confirms that the number of data processing times does not exceed the number of permission times even if the data processing is permitted in response to the current data processing request. When the number of permission times is larger than the number of data processing times, the processing request permission determination unit 240 determines that the number of data processing times falls within the number of permission times. When the number of data processing times falls within the number of permission times, the flow goes to Step S65. When the number of data processing times does not fall within the number of permission times, the flow goes to Step S68.

(Step S65) The processing request permission determination unit 240 transfers the data processing request to the owner IC card 20. At this point, the processing request permission determination unit 240 removes the agent card identifier added to the data processing request from the transferred data processing request.

(Step S66) The processing request permission determination unit 240 determines whether or not the owner IC card 20 sends back the processing result. When the owner IC card 20 sends back the processing result, the flow goes to Step S69. When the owner IC card 20 does not send back the processing result, the flow goes to Step S67.

(Step S67) The processing request permission determination unit 240 makes the timeout determination. The processing request permission determination unit 240 makes the timeout determination when the elapsed time after the data processing request is transferred exceeds a specific waiting time. When the processing request permission determination unit 240 makes the timeout determination, the flow goes to Step S68. When the processing request permission determination unit 240 does not make the timeout determination, the flow goes to Step S66, and the processing request permission determination unit 240 waits for the processing result of the owner IC card 20.

(Step S68) In the case of the authentication error, in the case where the current date and time is not within the permission date and time, in the case where the number of data processing times exceeds the number of permission times when the current data processing request is permitted, and/or in the case of the generation of the timeout, the processing request permission determination unit 240 sends back the invalid result to the agent device 100. Then the processing is ended.

(Step S69) When receiving the processing result from the owner IC card 20, the processing request permission determination unit 240 increments the number of data processing times.

(Step S70) The processing request permission determination unit 240 sends back the processing result to the agent device 100. Thus, the processing performed by the agent using the encryption data can be permitted only within the range of the commission conditions set by the owner.

In the first embodiment, it is assumed that the processing is performed by the public key system in which the encryption data is encrypted with the public key. Alternatively, the secret key in the owner IC card can be used in both the encryption and the decryption. In the case where the plaintext data is encrypted with the secret key 22, the data processing request transmitted from the management object system 300 includes the plaintext data which is desirably encrypted instead of the encryption data. In the owner IC card 20, the encryption is performed with the secret key 22, and the encryption data is transmitted as the processing result.

### Second Embodiment

In the first embodiment, the management object system 300 and the agent device 100 are connected to each other by inserting the card-type probe 102 in the IC card reader/writer 302. However, the connection can also be established by another method.

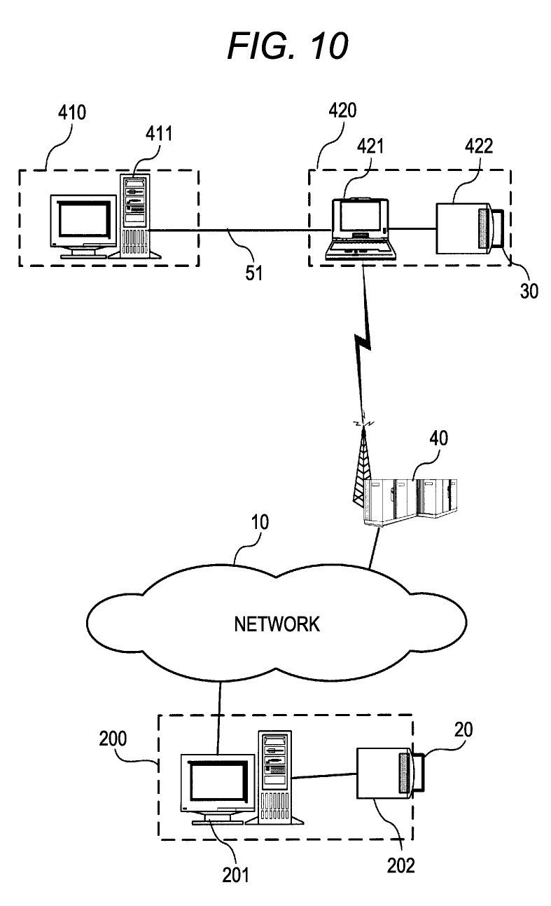

FIG. 10 illustrates an example of connection in which a USB interface is used. In FIG. 10, components similar to the components in FIG. 2 are designated by the same numerals, and the descriptions thereof are omitted.

A management object system 410 includes a device main body 411. A USB controller which conducts the data communication according to the USB interface standard is incorporated in the device main body 411. An agent device 420 includes a device main body 421 and an IC card reader/writer 422. The agent IC card 30 may be inserted in the IC card reader/writer 422. The IC card reader/writer 422 performs read/write to the memory in the agent IC card 30. A USB controller is incorporated in the device main body 421. The device main body 411 of the management object system 410 and the device main body 421 of the agent device 420 are connected by a USB cable 51.

The function of the management object system 410 is similar to that of the management object system 300 shown in FIG. 4. The function of the agent device 420 is similar to that of the agent device 100 shown in FIG. 4.

The connection mode of the second embodiment enables the agent device 420 having no card-type probe to be connected to the management object system 410. The management object system 410 transmits the request to perform the processing of the encryption data to the agent device 420 connected by the USB cable 51. Therefore, the request to perform the processing of the encryption data can be transmitted to the owner device 200 through the agent device 420.

### Third Embodiment

In a third embodiment, the agent IC card is incorporated as a virtual device in the device main body of the agent device.

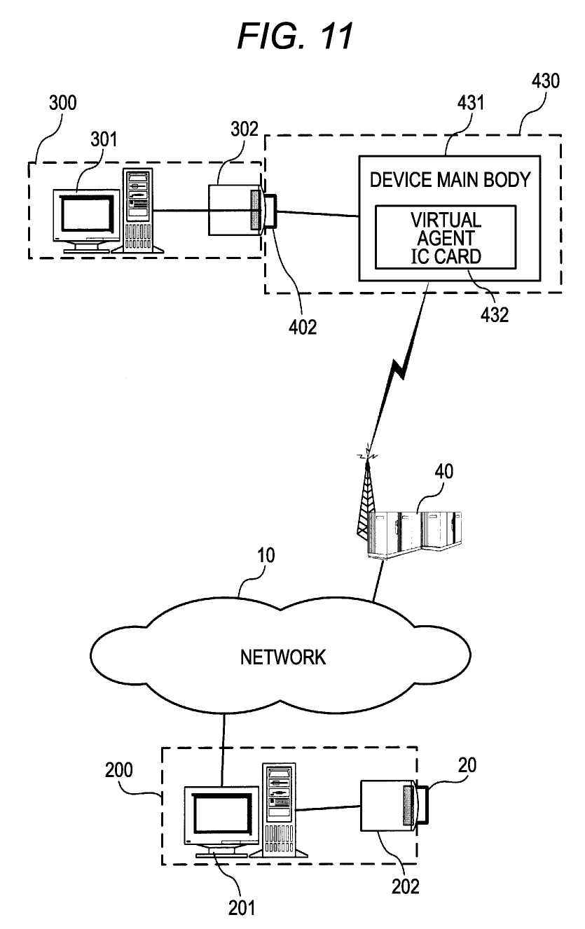

FIG. 11 illustrates an example in which the agent IC card function is incorporated in the device main body. In FIG. 11, components similar to of the components of FIG. 2 are designated by the same numerals, and the descriptions thereof are omitted.

In the example of FIG. 11, an agent device 430 includes a device main body 431 and a card-type probe 402. A virtual agent IC card 432 is incorporated in the device main body 431. In the virtual agent IC card 432, the function of the agent IC card 30 shown in FIG. 4 is realized via software in the device main body 431. The agent device 430 includes the function of the management object system 300 shown in FIG. 4.

Therefore, the authentication information on the agent and the like can be managed without using the agent IC card.

### Fourth Embodiment

In fourth embodiment, a plurality of owner IC cards can be used concurrently.

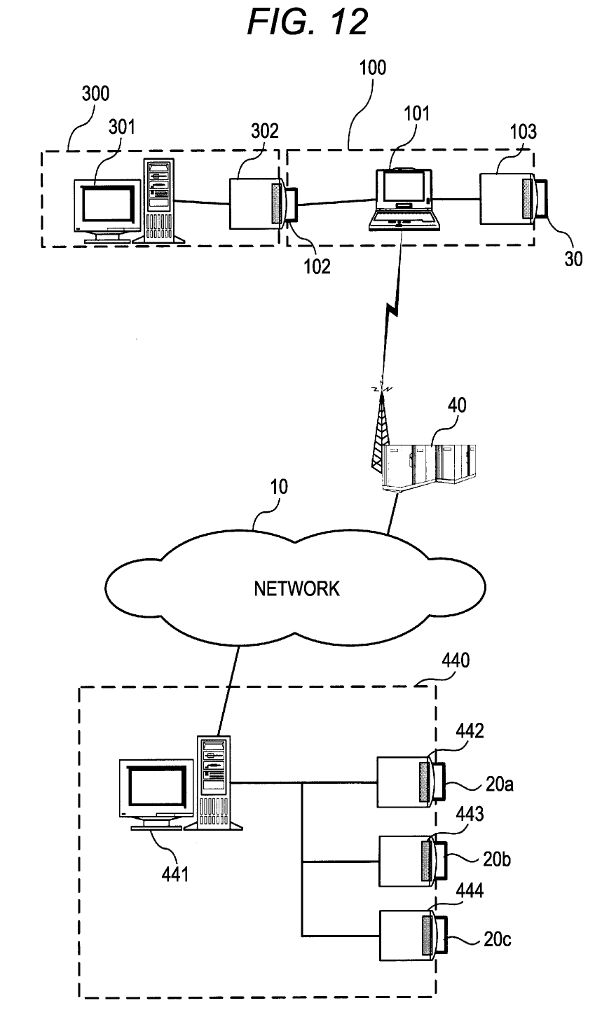

FIG. 12 illustrates an example of an owner device in which the plurality of owner IC cards can be used concurrently. In FIG. 12, components similar to those of FIG. 2 are designated by the same numerals, and the descriptions thereof are omitted.

An owner device 440 includes a device main body 441 and a plurality of IC card readers/writers 442 to 444. Owner IC cards 20a, 20b, and 20c are inserted in the IC card readers/writers 442, 443, and 444, respectively. The owner IC cards 20a, 20b, and 20c each have a different secret key. The owner device 440 includes the function of the owner device 200 shown in FIG. 4.

In the case of the use of the owner device 440, the data in the management object system 300 is encrypted with the different public keys, and the data processing can be performed with the encryption data only when the owner IC card having the encryption key corresponding to each public key is connected.

### Fifth Embodiment

In a fifth embodiment, a plurality of owner IC cards are incorporated as a virtual device in the device main body of the owner device.

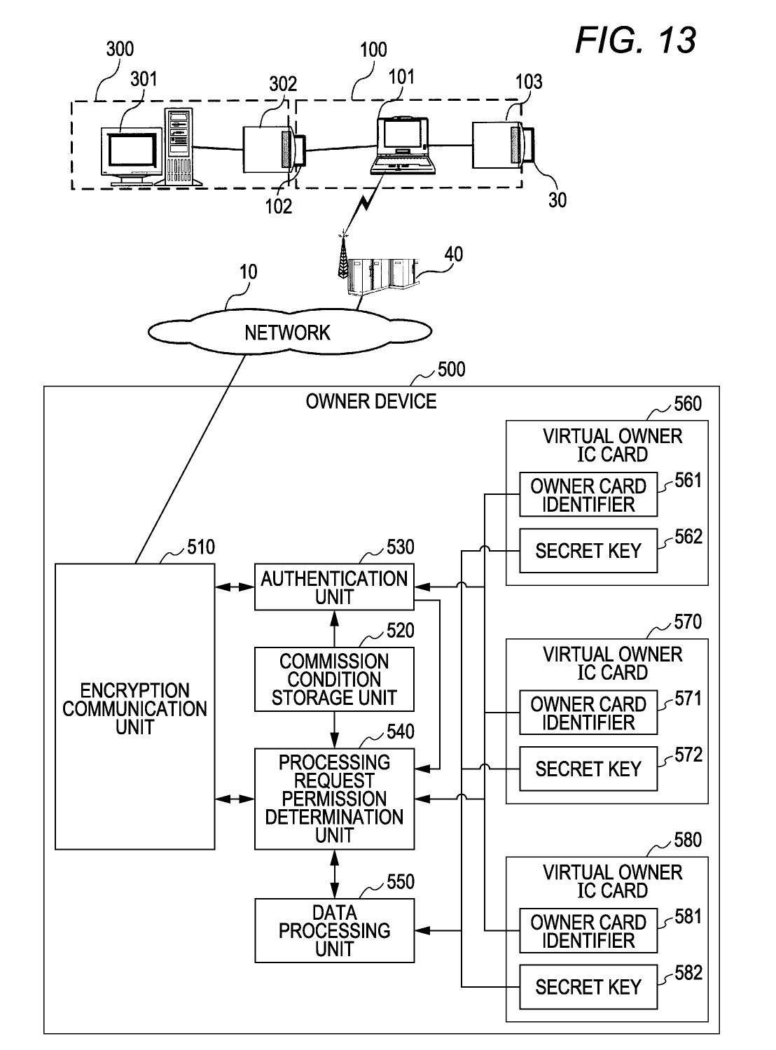

FIG. 13 illustrates an example in which a plurality of owner IC card functions are incorporated in the device main body. In FIG. 13, the components similar to those of FIG. 2 are designated by the same numerals, and the descriptions thereof are omitted.

An owner device 500 includes an encryption communication unit 510, a commission condition storage unit 520, an authentication unit 530, a processing request permission determination unit 540, a data processing unit 550, and a plurality of virtual owner IC cards 560, 570, and 580. Each of the encryption communication unit 510, the commission condition storage unit 520, the authentication unit 530, and the processing request permission determination unit 540 has the same function as that of the components of the owner device 200 shown in FIG. 4. However, the processing request permission determination unit 540 transfers the data processing request to the data processing unit 550.

The data processing unit 550 performs the data processing with each of the secret keys 562, 572, and 582 in the virtual owner IC cards 560, 570, and 580 in response to the data processing request transferred from the processing request permission determination unit 540. Examples of the data processing include the data encryption and the data decryption.

In the virtual owner IC cards 560, 570, and 580, the function of the owner IC card 20 shown in FIG. 4 is realized via software in the owner device 500. The virtual owner IC cards 560, 570, and 580 include owner card identifiers 561, 571, and 581 and secret keys 562, 572, and 582, respectively.

Thus, the use of the plurality of virtual owner IC cards 560, 570, and 580 eliminates the connection of the plural IC card readers/writers to the owner device even if the plurality of owner IC cards are used concurrently.

### Sixth Embodiment

In a sixth embodiment, the agent authentication is performed using the public key system encryption technique. The hardware configuration of the whole system of the sixth embodiment is similar to that of the first embodiment shown in FIG. 2.

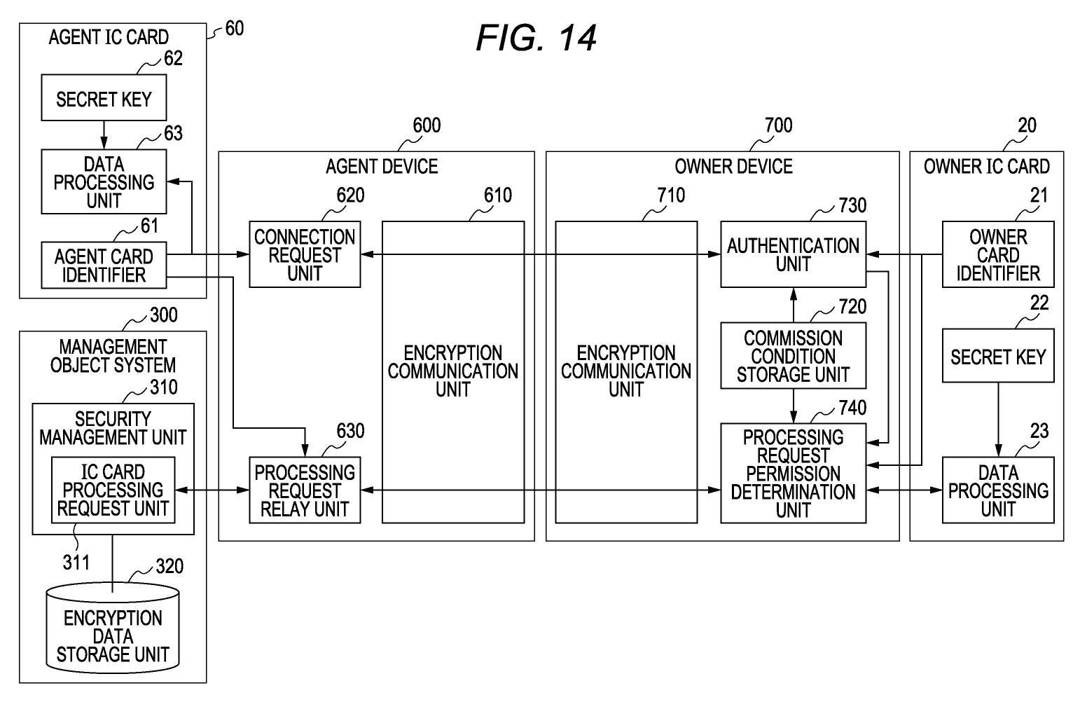

FIG. 14 is a functional block diagram illustrating a system in which the agent authentication is performed by the public key system. In FIG. 14, the components similar to those of FIG. 4 are designated by the same numerals, and the descriptions thereof are omitted.

Referring to FIG. 14, an agent IC card 60 includes an agent card identifier 61, a secret key 62, and a data processing unit 63. The agent card identifier 61 is identification information which is used to uniquely identify the agent IC card 60. The secret key 62 is key information which is used to decrypt the data encrypted with the public key for the agent IC card 60. The data processing unit 63 is a processing function of performing processing for decrypting the encryption data with the secret key 62.

An agent device 600 includes an encryption communication unit 610, a connection request unit 620, and a processing request relay unit 630. The encryption communication unit 610 has the same function as the encryption communication unit 110 shown in FIG. 4. The processing request relay unit 630 has the same function as the processing request relay unit 130 shown in FIG. 4.

When receiving the operation input for the instruction to connect the agent device 600 to an owner device 700, the connection request unit 620 transmits the connection request to the owner device 700 through the encryption communication unit 610. The owner device 700 sends back encryption data (an encrypted random number sequence) in which a random number is encrypted with the public key. When receiving the encrypted random number sequence, the connection request unit 620 transmits the encrypted random number sequence to the data processing unit 63 of the agent IC card 60. The data processing unit 63 sends back a random number sequence which is obtained by decrypting the encrypted random number with the secret key 62. When receiving the random number, the connection request unit 620 transmits the random number sequence as the authentication information to the owner device 700 through the encryption communication unit 610.

The owner device 700 includes an encryption communication unit 710, a commission condition storage unit 720, an authentication unit 730, and a processing request permission determination unit 740. The encryption communication unit 710 has the same function as the encryption communication unit 210 shown in FIG. 4. The processing request permission determination unit 740 has the same function as the processing request permission determination unit 240 shown in FIG. 4.

The public key and commission condition corresponding to the secret key 62 stored in the agent IC card 60 are stored in the commission condition storage unit 720. The public key and the secret key 62 are produced at the same time, and the data encrypted with the public key is decrypted only with the secret key 62.

The authentication unit 730 performs the agent authentication processing in response to the connection request from the agent device 600. When receiving the connection request from the agent device 600, the authentication unit 730 generates the random number sequence and stores the random number sequence in the memory. Then the authentication unit 730 obtains the public key corresponding to the agent IC card 60 from the commission condition storage unit 720, and encrypts the random number sequence with the obtained public key. At this point, the random number sequence before the encryption is directly stored in the memory. The authentication unit 730 transmits the encrypted random number sequence to the agent device 600. When the agent device 600 transmits the random number sequence that is the authentication information, the authentication unit 730 checks the received random number sequence with the random number sequence stored in the memory. When the received random number sequence matches the random number sequence stored in the memory, the authentication unit 730 determines that the authentication is successfully performed.

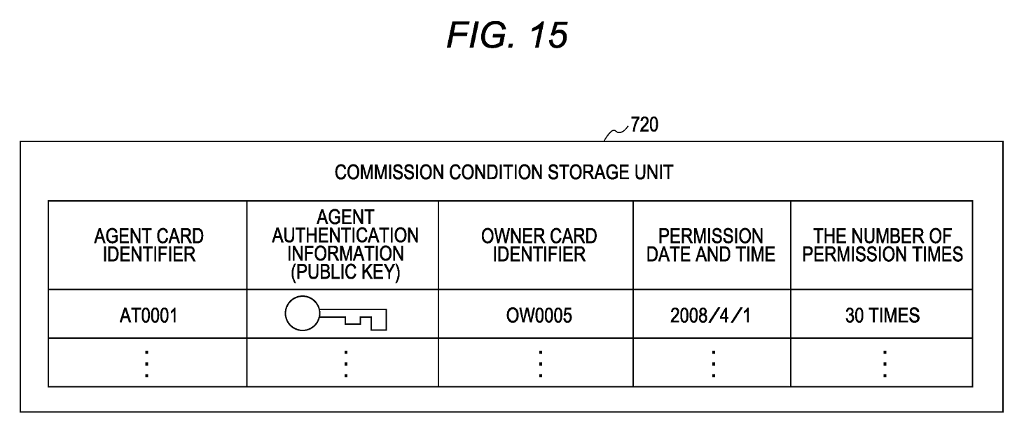

FIG. 15 illustrates an example of a data structure of the commission condition storage unit. The fields such as the agent card identifier, agent authentication information, the owner card identifier, the permission date and time, and the number of permission times are provided in the commission condition storage unit 720. The pieces of information stored in the fields, except for the agent authentication information, are identical to those of the commission condition storage unit 220 shown in FIG. 5. The public key is set as the agent authentication information in the agent authentication information field.

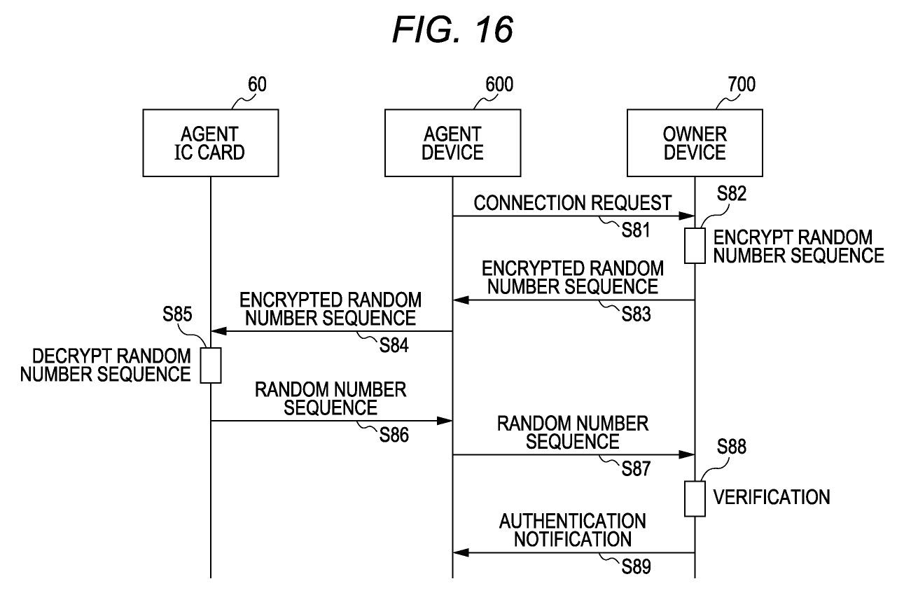

FIG. 16 is a sequence diagram illustrating an authentication procedure in which the public key is used. FIG. 16 illustrates the processing performed by the agent IC card 60, the agent device 600, and the owner device 700. The pieces of processing shown in FIG. 16 will be described below along the Step number.

(Step S81) The agent device 600 transmits the connection request to the owner device 200 in response to the operation input from the agent. The connection request unit 620 of the agent device 600 accepts the operation input for instructing the connection to the owner device 700. Then the connection request unit 620 obtains the agent card identifier 61 from the agent IC card 60. The connection request unit 620 produces the connection request including the agent card identifier 61. The produced connection request is encrypted by the encryption communication unit 610 and transmitted to the owner device 700 through the wireless communication.

(Step S82) The owner device 700 produces and encrypts the random number sequence. When receiving the connection request, the authentication unit 730 of the owner device 700 produces the random number sequence. The authentication unit 730 stores the produced random number sequence in the memory such as RAM while correlating the random number sequence with the agent card identifier 61 included in the connection request. Then the authentication unit 730 retrieves the public key corresponding to the agent card identifier 61 included in the connection request from the commission condition storage unit 720. The authentication unit 730 produces a duplicate of the random number sequence stored in the memory, and encrypts the duplicated random number sequence using the retrieved public key.

(Step S83) The authentication unit 730 of the owner device 700 transmits the encrypted random number sequence (encrypted random number sequence) to the agent device.

(Step S84) The connection request unit 620 of the agent device 600 transfers the encrypted random number sequence, transmitted from the owner device 700, to the agent IC card 60.

(Step S85) The agent IC card 60 decrypts the random number sequence. The data processing unit 63 of the agent IC card 60 decrypts the received encrypted random number sequence with the secret key 62.

(Step S86) The data processing unit 63 of the agent IC card 60 imparts the agent card identifier 61 to the decrypted random number sequence and transmits the random number sequence to the agent device 600.

(Step S87) The connection request unit 620 of the agent device 600 transfers the random number sequence, transmitted from the agent IC card 60, to the owner device 700.

(Step S88) The owner device 700 verifies the random number sequence transmitted from the agent device 600. Based on the agent card identifier imparted to the random number sequence transmitted from the agent device 600, the authentication unit 730 of the owner device 700 reads the random number sequence corresponding to the agent card identifier from the memory. The authentication unit 730 checks the random number sequence read from the memory with the random number sequence transmitted from the agent device 600. When the random number sequence read from the memory matches the random number sequence transmitted from the agent device 600, the authentication unit 730 correctly authenticates the agent IC card 60.

(Step S89) In the case of the correct authentication, the authentication unit 730 of the owner device 700 transmits the authentication notification indicating the correct authentication to the agent device 600.

Thus, the use of the unauthorized agent IC card 60 (for example, unauthorized use by forgery of agent card identifier) can be prevented. In the sixth embodiment, the configuration can be changed as shown in the second to fifth embodiments.

The processing function of each of the above-described embodiments can be realized by the computer. In such cases, there is provided the program in which processing contents of the functions to be possessed by the device main bodies of the agent device, owner device, and management object system are described. The program is executed by the computer, thereby realizing processing functions on the computer. The program in which processing contents are described can be recorded in a computer-readable recording medium. Examples of the computer-readable recording medium include a magnetic recording device, an optical disk, a magneto-optical recording medium, and a semiconductor memory. Examples of the magnetic recording device include a Hard Disk Drive (HDD), a Flexible Disk (FD) and a magnetic tape. Examples of the optical disk include DVD (Digital Versatile Disc), DVD-RAM, CD-ROM (Compact Disc Read Only Memory), and CD-R (Recordable)/RW (Re Writable). An example of the magneto-optical recording medium includes MO (Magneto-Optical disc).

For example, a portable recording medium such as DVD and CD-ROM in which the program is recorded may be sold when the program is circulated. Alternatively, the program may be stored in the storage device of the server computer and the program can be transferred from the server computer to other computers through the network.

The computer which executes the program stores the program recorded in the portable recording medium or the program transferred from the server computer in the storage device thereof. Then, the computer reads the program from the storage device to perform the processing according to the program. Alternatively, the computer may directly read the program from the portable recording medium to perform the processing according to the program. Alternatively, the computer may perform the processing according to the received program every time the program is transferred from the server computer.

The invention is not limited to the above-described embodiments, but various modifications can be made without departing from the scope of the invention.

What is claimed is:

1. An encryption data management system which includes an agent-side apparatus and an owner-side apparatus to manage encryption data stored in an encryption data storage unit of a management object apparatus,
wherein the agent-side apparatus includes:
a transmission unit which responds to an operation input from an agent and transmits authentication information indicating proxy of the agent to the owner-side apparatus; and
a transfer unit which transfers a data processing request including the encryption data to the owner-side apparatus when the management object apparatus supplies the data processing request, and transfers a processing result to the management object apparatus, the processing result corresponding to the data processing request sent back from the owner-side apparatus,
wherein the owner-side apparatus includes:
a commission condition storage unit in which a commission condition of the agent who uses the agent-side apparatus is previously stored;
an agent authentication unit which authenticates authentication information when the authentication information of the agent is received from the agent-side apparatus;
a performing unit which performs data processing associated with decryption of the encryption data included in the permitted data processing request using a previously registered key, when the agent authentication unit normally performs the authentication, and when the data processing request falls within a range of the agent commission condition indicated by the commission condition storage unit, upon receiving the data processing request from the agent-side apparatus; and
a result transmission unit which transmits a processing result of the performing unit to the agent-side apparatus.

2. The encryption data management system according to claim 1, wherein the encryption data stored in the encryption data storage unit of the management object apparatus is encrypted using a public key,
the owner-side apparatus has a secret key corresponding to the public key, and
the performing unit decrypts the encryption data using the secret key.

3. The encryption data management system according to claim 2, wherein the owner-side apparatus includes:
an IC card reader/writer which may be connected to an owner IC card, the owner IC card including the secret key and data processing unit which performs decryption processing of the encryption data with the secret key; and
an owner device apparatus,
the owner device apparatus including:
the commission condition storage unit;
the agent authentication unit which checks the authentication information with the verification authentication information in the commission condition storage unit to authenticate proxy of an agent who operates the agent-side apparatus when the authentication information is received from the agent-side apparatus;
processing request permission determination unit which causes the data processing unit in the owner IC card to perform data processing associated with decryption of the encryption data included in the permitted data processing request using a previously registered key, when the agent authentication unit authenticates the authentication information transmitted from the agent-side apparatus, and when the data processing request falls within a range of the agent commission condition, upon receiving the data processing request from the agent-side apparatus; and the result transmission unit.

4. The encryption data management system according to claim 1, wherein the agent-side apparatus transmits the previously registered authentication information upon transmitting the authentication information,
verification authentication information is previously registered in the owner-side apparatus in order to authenticate an agent to whom proxy is imparted, and
the agent authentication unit performs authentication processing by checking the authentication information with the verification authentication information when the agent authentication unit receives the authentication information from the agent-side apparatus.

5. The encryption data management system according to claim 4, wherein the agent-side apparatus includes:
an IC card reader/writer which can be connected to an agent IC card in which the authentication information is stored; and
an agent device apparatus,
the agent device apparatus including:
a transmission unit which responds to an operation input from the agent and obtains the authentication information from the agent IC card to transmit the authentication information to the owner-side apparatus; and
a transfer unit which transfers the data processing request supplied from the management object apparatus to the owner side apparatus and transfers a processing result to the management object apparatus, the processing result being sent back from the owner-side apparatus in response to the data processing request.

6. The encryption data management system according to claim 1, wherein the agent-side apparatus transmits a connection request to the owner-side apparatus when transmitting the authentication information, the agent-side apparatus decrypts an encrypted random number sequence sent back in response to the connection request to produce a decrypted random number sequence using a previously registered secret key, and the agent-side apparatus transmits the decrypted random number sequence as authentication information to the owner-side apparatus, and
the owner-side apparatus produces a random number sequence in response to the connection request transmitted from the agent-side apparatus when authenticating the agent, the owner-side apparatus encrypts the random number sequence to produce the encrypted random number sequence using a public key which is previously registered and corresponds to the agent-side apparatus, the owner-side apparatus transmits the encrypted random number sequence to the agent-side apparatus, and the owner-side apparatus performs authentication by checking the produced random number sequence with the decrypted random number sequence which is transmitted as the authentication information from the agent-side apparatus.

7. The encryption data management system according to claim 6, wherein the agent-side apparatus includes:
an agent IC card which includes the secret key and data processing unit which performs decryption processing of the encrypted random number sequence with the secret key; and
an agent device apparatus,
the agent device apparatus including:
an IC card reader/writer which can be connected to the agent IC card;
a transmission unit which transmits a connection request to the owner-side apparatus in response to an operation input from the agent, causes the agent IC card to decrypt the encrypted random number sequence sent back in response to the connection request, and transmits the decrypted random number sequence produced by the decryption as the authentication information to the owner-side apparatus; and
a transfer unit which transfers the data processing request supplied from the management object apparatus to the owner-side apparatus and transferring processing result to the management object apparatus, the processing result being sent back from the owner-side apparatus in response to the data processing request.

8. The encryption data management system according to claim 1, wherein a date and a time when the data processing is permitted by the proxy are defined in the commission condition.

9. The encryption data management system according to claim 1, wherein a limit value of the number of times the data processing is permitted by the proxy is defined in the commission condition.

10. The encryption data management system according to claim 1, wherein the agent-side apparatus includes a card-type probe which can be inserted in an IC card reader/writer connected to the management object system, and
the agent-side apparatus receives the data processing request through the card-type probe.

11. An encryption data management method performed by an encryption data management system which includes an agent-side apparatus and an owner-side apparatus to manage encryption data stored in encryption data storage unit of a management object apparatus,
wherein the agent-side apparatus
responds to an operation input from an agent to transmit authentication information indicating proxy of the agent to the owner-side apparatus;
transfers a data processing request including the encryption data to the owner-side apparatus when the management object apparatus supplies the data processing request; and
transfers a processing result to the management object apparatus, the processing result corresponding to the data processing request sent back from the owner-side apparatus,
wherein the owner-side apparatus can access the commission condition storage unit in which a commission condition of the agent who uses the agent-side apparatus is previously stored;
authenticates authentication information when the authentication information of the agent is received from the agent-side apparatus;
performs data processing associated with decryption of the encryption data included in the permitted data processing request using a previously registered key, when the authentication is normally performed, and when the data processing request falls within a range of the agent commission condition indicated by the commission condition storage unit, in receiving the data processing request from the agent-side apparatus; and
transmits a processing result of the data processing to the agent-side apparatus.
